(19) United States
(12) Patent Application Publication
(10) Pub. No.: US 2025/0083739 A1
(43) Pub. Date: Mar. 13, 2025

(54) Apparatus and Method for Detecting Damage to a Steering System

(71) Applicant: Robert Bosch GmbH, Stuttgart (DE)

(72) Inventors: Markus Weber, Goeppingen (DE); Stefan Ehlert, Goeppingen (DE); Steffen Kuhn, Urbach (DE); Thomas Kuehnhoefer, Heubach (DE); Reinhard Grossheim, Abtsgmuend (DE); Tobias Abele, Moegglingen (DE); Walter Gronbach, Kohlberg (DE)

(21) Appl. No.: 18/800,419

(22) Filed: Aug. 12, 2024

(30) Foreign Application Priority Data
Sep. 12, 2023 (DE) 10 2023 208 835.5

(51) Int. Cl. B62D 5/04

(52) U.S. Cl. CPC B62D 5/0496

(57) ABSTRACT

An apparatus and method for detecting damage to a steering system, wherein values of moisture in the steering system are determined with a sensor within the steering system, wherein the damage is detected as a function of the values.

This application claims priority under 35 U.S.C. § 119 to application no. DE 10 2023 208 835.5, filed on Sep. 12, 2023 in Germany, the disclosure of which is incorporated herein by reference in its entirety.

### BACKGROUND

The disclosure relates to an apparatus and method for detecting damage to a steering system.

The steering system comprises mechanics and electronics to be protected from water. In the steering system, air is specifically exchanged between the air in the steering system and the outside air via a pressure equalization element.

### SUMMARY

The method and apparatus according to the disclosure provide detection of damage to a steering system.

The method for detecting damage to a steering system provides that values of moisture in the steering system are determined with a sensor within the steering system, wherein the damage is detected as a function of the values.

It may be provided that values of a temperature in the steering system are determined in particular with the sensor, wherein a distance of the temperature to a dew point temperature is detected, and the damage is detected as a function of the distance, in particular if the distance is less than a threshold value. Due to the pressure equalization element, the moisture or a dew point or a distance between the temperature and the dew point temperature within the steering system changes with different dynamics in an undamaged steering system than in a damaged steering system. The method detects the damage or water in the steering system as a function of the values of the sensor.

Preferably, a moisture gradient is determined as a function of the values, wherein the damage is detected as a function of the moisture gradient. The moisture gradient represents the dynamics.

In one embodiment, the damage is detected when the moisture gradient is greater than a threshold value. The threshold value allows excessive dynamics to be detected.

In one embodiment, the damage is detected when a deviation of at least one of the values from a reference curve for the moisture or the moisture gradient is detected. The reference curve allows detection of a deviation from an expected dynamic.

In one embodiment, the damage is detected using artificial intelligence, which is configured to map the values to a classification, wherein the damage is detected as a function of the classification.

The apparatus for detecting damage to a steering system comprises a sensor, which is configured to detect values of moisture in the steering system within the steering system, wherein the apparatus comprises a device for detection, which is configured to detect the damage of the steering system as a function of the values. For example, the sensor is arranged on a printed circuit board in the steering system.

The apparatus is preferably configured to determine a temperature in the steering system, in particular with the sensor, to detect a distance between the temperature and a dew point temperature, and to detect the damage as a function of the distance, in particular if the distance is less than a threshold value.

The device is preferably configured to determine a moisture gradient as a function of the values and to detect the damage as a function of the moisture gradient.

In one embodiment of the apparatus, the device is configured to detect the damage when the moisture gradient is greater than a threshold value. The threshold value allows excessive dynamics to be detected.

In one embodiment of the apparatus, the device is configured to detect a deviation of at least one of the values from a reference curve for the moisture or the moisture gradient and to detect the damage when the deviation of at least one of the values from the reference curve for the moisture or the moisture gradient is detected. The reference curve allows detection of a deviation from an expected dynamic.

In one embodiment of the apparatus, the device comprises artificial intelligence, which is configured to map the values to a classification and to detect the damage as a function of the classification.

A vehicle comprising the steering system and the apparatus has advantages corresponding to those of the apparatus.

### BRIEF DESCRIPTION OF THE DRAWINGS

Further advantageous embodiments will become apparent from the following description and the drawings. The drawings show:

FIG. 1 a schematic illustration of a vehicle,

FIG. 2 a schematic illustration of a method for detecting damage to a steering system,

FIG. 3 exemplary temporal paths of moisture in the steering system.

### DETAILED DESCRIPTION

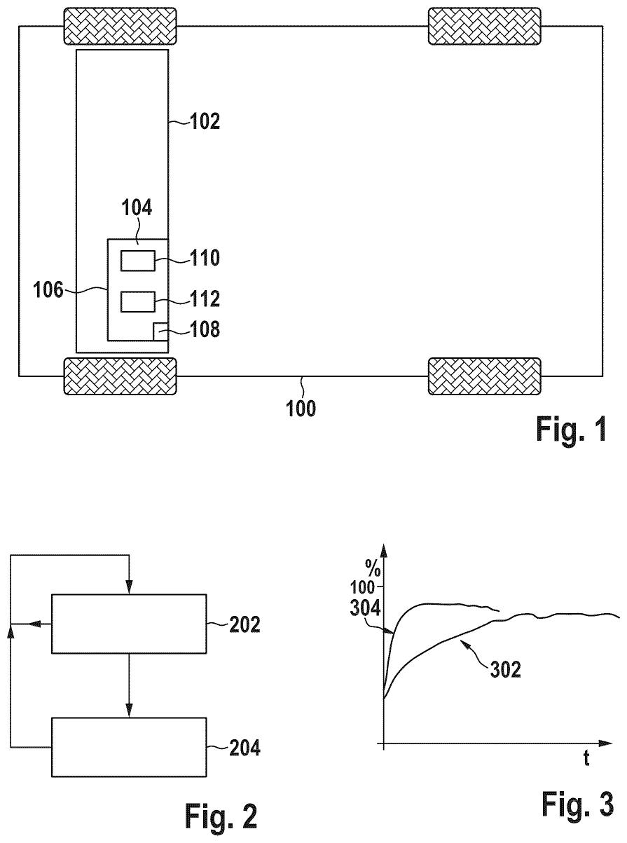

A vehicle 100 is shown schematically in FIG. 1.

The vehicle 100 comprises a steering system 102 and a device 104 for detecting damage to the steering system 102. The steering system 102 comprises electronics that are protected from water by a housing 106 of the steering system 102. The housing 106 comprises a pressure equalization element 108 that allows air exchange between the air in the steering system 102, i.e., in the housing 106, and the outside air. The pressure equalization element 108 limits the air exchange, such that moisture within the steering system 102, i.e. within the housing 106, can only change slowly.

A change in the values of the moisture is known with the undamaged steering system 102.

The device 104 comprises a sensor 110, in particular a moisture sensor. The sensor 110 is arranged in the steering system 102, in the example within the housing 106. The sensor 110 is configured to detect values of moisture in the steering system 102. It may be contemplated that the sensor 110 is configured to detect values of a temperature in the steering system 102. For example, the sensor system 110 is arranged on a printed circuit board which comprises the electronics of the steering system 102.

The device 104 comprises a device 112 for detection, which is configured to detect damage to the steering system 102 as a function of values of moisture. In the example, the electronics include the device 112.

For example, the device 112 is configured to detect the damage when a moisture gradient in the steering system 102, i.e., in the housing 106, is greater than a threshold value.

It may be contemplated that the device 112 is configured to detect the damage as a function of a distance of the temperature from a predetermined dew point temperature, e.g., when the distance between the temperature and the predetermined dew point temperature in the steering system 102, i.e., in the housing 106, is less than a threshold value.

The device 112 is configured, for example, to detect a deviation of at least one of the values from a reference curve for the moisture and to detect the damage when the deviation of at least one of the values from the reference curve for the moisture is detected.

The device 112 is configured, for example, to detect a deviation of at least one of the values from a reference curve for the moisture gradient and to detect the damage when the deviation of at least one of the values from the reference curve for the moisture gradient is detected.

For example, the device 112 comprises artificial intelligence, which is configured to map the values to a classification and to detect the damage as a function of the classification.

FIG. 2 shows steps in a method for determining the damage.

The method comprises a step 202.

In step 202, a value of the moisture and optionally the temperature in the steering system 102 is determined with the sensor 110.

Subsequently, a step 204 is carried out.

It may be contemplated that step 202 is be performed repeatedly to detect multiple values of moisture and optionally of temperature before step 204 is performed.

In step 204, either the damage is detected or no damage is detected as a function of the value of the moisture and optionally the temperature.

Step 202 is then carried out.

In the example, multiple values of the moisture in the steering system 102 are detected with the sensor 110, a moisture gradient is determined as a function of the values, and the damage is detected as a function of the moisture gradient.

It may be contemplated that the threshold value for allowable changes in moisture is predetermined and the damage is detected when the moisture gradient is greater than the threshold value.

It may be contemplated that the reference curve is provided for allowable values of the moisture and the damage is detected when a deviation of the value of the moisture from the reference curve is detected.

It may be contemplated that the reference curve is provided for allowable changes of the moisture and the damage is detected when a deviation of at least one of the values from the reference curve is detected.

Optionally, it may be provided that a value of the temperature in the steering system 102 is detected with the sensor 110 and the distance between the temperature and the dew point temperature is determined as a function of the value of the temperature and the damage as a function of the distance.

It may be contemplated that the threshold value is predetermined for an allowable distance and the damage is detected when the distance is below the threshold value.

It may be contemplated that the damage is detected using artificial intelligence. For example, the value or values are mapped to a classification using artificial intelligence. For example, the damage is detected as a function of the classification. For example, the classification indicates in binary form whether or not damage is detected.

FIG. 3 shows exemplary temporal paths of moisture in the steering system 102. The moisture is specified in %. A first path 302 of moisture over time t differs from a second path 304 of moisture over time t by its dynamics. The first path 302 is less dynamic than the second path 304. The first path 302 in the example is a reference curve for a tight steering system 102. The second path 304 in the example is a path of values that the sensor 110 detects when the steering system 102 is not tight.

For example, the threshold value for a value of the moisture measured at a time t is the value associated with that time from the first path 302. For example, the deviation of the value from the reference curve is determined as the deviation of the value measured at a point in time from the moisture value associated with that time point in the first path 302. For example, the points in time associated with each other are determined by a calibration of the measured values and the values from the first path 302 assuming a tight steering system 102.

The artificial intelligence is trained, for example, by means of values of moisture and optionally of temperature measured in tests for a tight and untight steering system 102 by the sensor 110. For the respective value, it is therefore known whether it is to be classified as damage, i.e., an untight steering system 102, or not.

What is claimed is:

1. A method for detecting damage to a steering system, comprising:
determining with a sensor within the steering system values of moisture in the steering system; and
detecting the damage as a function of the determined values.

2. The method according to claim 1, wherein:
determining with the sensor includes determining values of a temperature in the steering system;
the method includes determining a distance of the temperature to a dew point temperature; and
detecting the damage includes detecting the damage as a function of the determined distance, in response to the distance being less than a threshold value.

3. The method according to claim 1, wherein:
a moisture gradient is determined as a function of the values; and
detecting the damage includes detecting the damage as a function of the determined moisture gradient.

4. The method according to claim 3, wherein detecting the damage includes detecting the damage as a function of the determined moisture gradient in response to the determined moisture gradient being greater than a threshold value.

5. The method according to claim 3, wherein the damage is detected in response to detection of a deviation of at least one of the determined values from a reference curve for the moisture or the moisture gradient.

6. The method according to claim 1, wherein:
the damage is detected using artificial intelligence which is configured to map the determined values to a classification; and
the damage is further detected as a function of the classification.

7. An apparatus for detecting damage to a steering system, comprising:
a sensor within the steering system configured to detect values of moisture in the steering system; and
a device configured to detect the damage to the steering system as a function of the detected values.

8. The apparatus according to claim 7, wherein:
the apparatus is configured to determine a temperature in the steering system with the sensor;
the apparatus is configured to detect a distance between the determined temperature and a dew point temperature; and
the device is configured to detect the damage as a function of the distance in response to the distance being less than a threshold value.

9. The apparatus according to claim 7, wherein:
the device is configured to determine a moisture gradient as a function of the detected values and to detect the damage as a function of the moisture gradient.

10. The apparatus according to claim 9, wherein the device is configured to detect the damage when the moisture gradient is greater than a threshold value.

11. The apparatus according to claim 7, wherein:
the device is configured to detect a deviation of at least one of the values from a reference curve for the moisture or a moisture gradient; and
the device is configured to detect the damage when the deviation of at least one of the values from the reference curve for the moisture or the moisture gradient is detected.

12. The apparatus according to claim 7, wherein the device comprises artificial intelligence which is configured to map the values to a classification and to detect the damage as a function of the classification.

13. A vehicle, comprising:
a steering system; and
the apparatus of claim 7.
